(19) United States
(12) Patent Application Publication
(10) Pub. No.: US 2005/0181845 A1
(43) Pub. Date: Aug. 18, 2005

(54) Wireless intercommunicating apparatus including an auxiliary device having built-in speaker and microphone

(75) Inventor: Apin Chang, Chung-Ho City (TW)

Correspondence Address: THE WEBB LAW FIRM, P.C., 700 KOPPERS BUILDING, 436 SEVENTH AVENUE, PITTSBURGH, PA, 15219, US

(73) Assignee: WINTECRONICS CO., LTD.

(21) Appl. No.: 10/777,450

(22) Filed: Feb. 12, 2004

(51) Int. Cl. H04B 1/38

(52) U.S. Cl. 455/575.2; 455/575.6; 455/569.1; 455/557

(57) ABSTRACT

A wireless intercommunicating apparatus includes a wireless intercommunicating device capable of outputting an audio signal corresponding to an incoming radio frequency signal received thereby, and a driving signal generated upon detecting generation of the audio signal. An auxiliary device is coupled to the wireless intercommunicating device, and includes an earphone switch port switched so as to enable an earphone to reproduce the audio signal from the wireless intercommunicating device when the earphone is connected to the earphone switch port, and a signal indicating unit driven by the driving signal from the wireless intercommunicating device so as to indicate receipt of the incoming radio frequency signal by the wireless intercommunicating device.

### BACKGROUND OF THE INVENTION

1. Field of the Invention

The invention relates to a wireless intercommunicating apparatus, more particularly to a wireless intercommunicating apparatus including an auxiliary device that has an auxiliary speaker and an auxiliary microphone built therein.

2. Description of the Related Art

Referring to FIG. 1, a conventional wireless intercommunicating apparatus 1 is shown to include a wireless intercommunicating device 10 and an auxiliary device 20.

The wireless intercommunicating device 10 includes an antenna 11, a first switch member 17, a second switch member 15, a receiver 12 interconnecting electrically the antenna 11 and the first switch member 17 for receiving an incoming radio frequency signal via the antenna 11, a transmitter 16 interconnecting electrically the antenna 11 and the second switch member 15, a primary speaker 18 coupled to the first switch member 17, and a primary microphone 19 coupled to the second switch member 15 for receiving an incoming audio signal.

The receiver 12 generates an audio signal corresponding to the incoming radio frequency signal in a known manner, and outputs the audio signal via the first switch member 17.

When the wireless intercommunicating device 10 is used independently, the receiver 12 is connected electrically to the primary speaker 18 via the first switch member 17 such that the primary speaker 18 can reproduce the audio signal from the receiver 12, and the transmitter 16 is connected electrically to the primary microphone 19 via the second switch member 15 such that the incoming audio signal received by the primary microphone 19 is transmitted to the transmitter 16.

The auxiliary device 20 includes an earphone switch port 25 connected selectively to an earphone 26, a first coupling member 23 wiredly connected to the earphone switchport 25 and connected detachably and electrically to the first switch member 17 of the wireless intercommunicating device 10, an auxiliary speaker 21 coupled to the earphone switch port 25, an auxiliary microphone 22 for receiving an incoming audio signal, and a second coupling member 22 connected to the auxiliary microphone 22 and connected detachably and electrically to the second switch member 15 of the wireless intercommunicating device 10.

When the first and second coupling members 23, 24 are connected electrically and respectively to the first and second switch members 17, 19, the primary speaker 18 is disconnected from the receiver 12, and the primary microphone 19 is disconnected from the transmitter 16. Moreover, when the earphone 26 is connected to the earphone switch port 25, the earphone switch port 25 switches operation from a first state, where the first coupling member 23 is connected electrically to the auxiliary speaker 21 such that the auxiliary speaker 21 reproduces the audio signal from the receiver 12, to a second state, where the first coupling member 23 is disconnected from the auxiliary speaker 21 and enables the earphone 26 to reproduce the audio signal from the receiver 12 of the wireless intercommunicating device 10. At the same time, the incoming audio signal received by the auxiliary microphone 22 is transmitted to the transmitter 16 of the wireless intercommunicating device 10 via the second coupling member 24 and the second switch member 15.

However, since the audio signal transmitted to the earphone 26 is not attenuated when the earphone switch port 25 is in the second state, the audio signal reproduced by the earphone 26 has a relatively large volume that makes the wearer feel uncomfortable, and that may even result in danger in case of on-duty wear, such as when used by a policeman or a fireman. Furthermore, when the conventional wireless intercommunicating apparatus 1 is used in a noisy environment while the earphone switch port 25 is in the first state, the user is not notified of the receipt of the incoming radio frequency signal by the wireless intercommunicating device 10.

### SUMMARY OF THE INVENTION

Therefore, the object of the present invention is to provide a wireless intercommunicating apparatus of the above-mentioned type that can eliminate the aforesaid drawbacks of the prior art.

According to the present invention, a wireless intercommunicating apparatus comprises:
a wireless intercommunicating device including
   a primary housing,
   an antenna mounted on the primary housing,
   a first switch member mounted on the primary housing,
   a second switch member mounted on the primary housing,
   a receiver mounted in the primary housing and interconnecting electrically the antenna and the first switch member for receiving an incoming radio frequency signal via the antenna, the receiver generating an audio signal corresponding to the incoming radio frequency signal and outputting the audio signal via the first switch member,
   a transmitter mounted in the primary housing and interconnecting electrically the second switch member and the antenna, and
   a processor mounted in the primary housing, connected electrically to the receiver and the second switch member, generating a driving signal upon detecting generation of the audio signal, and outputting the driving signal via the second switch member; and
an auxiliary device including
   an auxiliary housing,
   an earphone switch port mounted on the auxiliary housing and adapted to be connected to an earphone,
   a first coupling member wiredly connected to the earphone switch port and connected detachably and electrically to the first switch member of the wireless intercommunicating device,
   an auxiliary speaker mounted in the auxiliary housing and coupled to the earphone switch port,
   the earphone switchport switching operation from a first state, where the first coupling member is connected electrically to the auxiliary speaker such that the auxiliary speaker reproduces the audio signal from the receiver of the wireless intercommunicating device when the earphone switch port is disconnected from the earphone, to a second state, where the first coupling member is disconnected from the auxiliary speaker and enables the earphone to reproduce the audio signal from the receiver of the wireless intercommunicating device when the earphone switch port is connected to the earphone,
   an auxiliary microphone mounted on the auxiliary housing for receiving an incoming audio signal,
   a second coupling member wiredly connected to the auxiliary microphone and connected detachably and electrically to the second switch member of the wireless intercommunicating device such that the incoming audio signal received by the auxiliary microphone is transmitted to the transmitter of the wireless intercommunicating device via the second coupling member and the second switch member, and
   a signal indicating unit connected electrically to the second coupling member and driven by the driving signal from the processor of the wireless intercommunicating device via the second switch member and the second coupling member so as to indicate receipt of the incoming radio frequency signal by the wireless intercommunicating device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a conventional wireless intercommunicating apparatus;

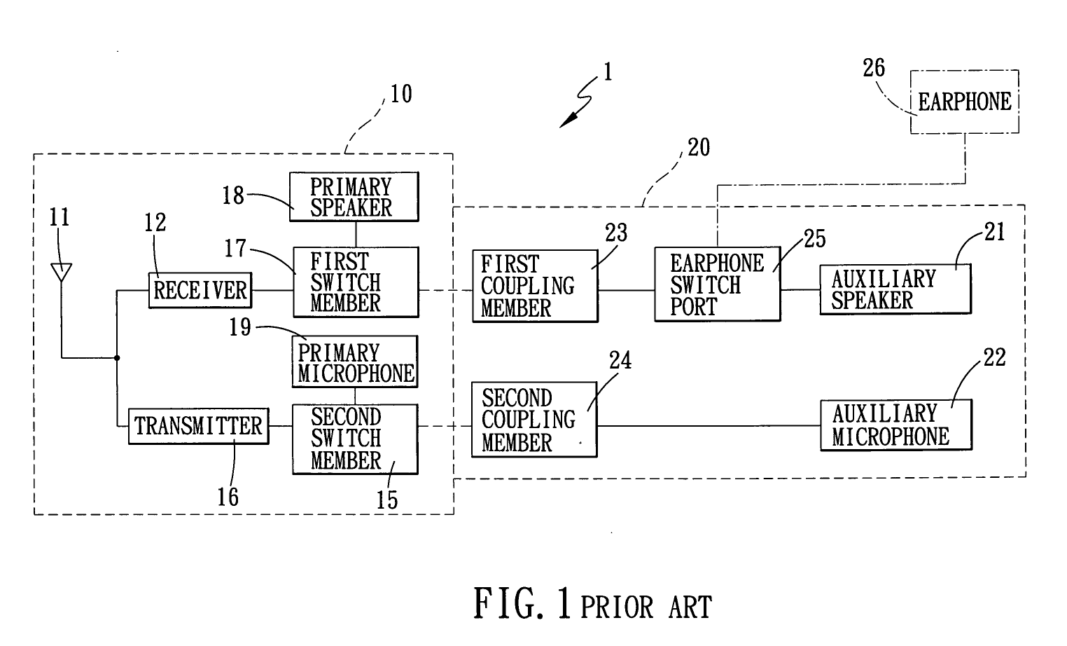

FIG. 2 is a schematic view showing the preferred embodiment of a wireless intercommunicating apparatus according to the present invention;

FIG. 3 is a schematic circuit block diagram of the preferred embodiment; and

FIG. 4 is a schematic electrical circuit diagram of the preferred embodiment.

### DETAILED DESCRIPTION OF THE PREFERRED EMBODIMENT

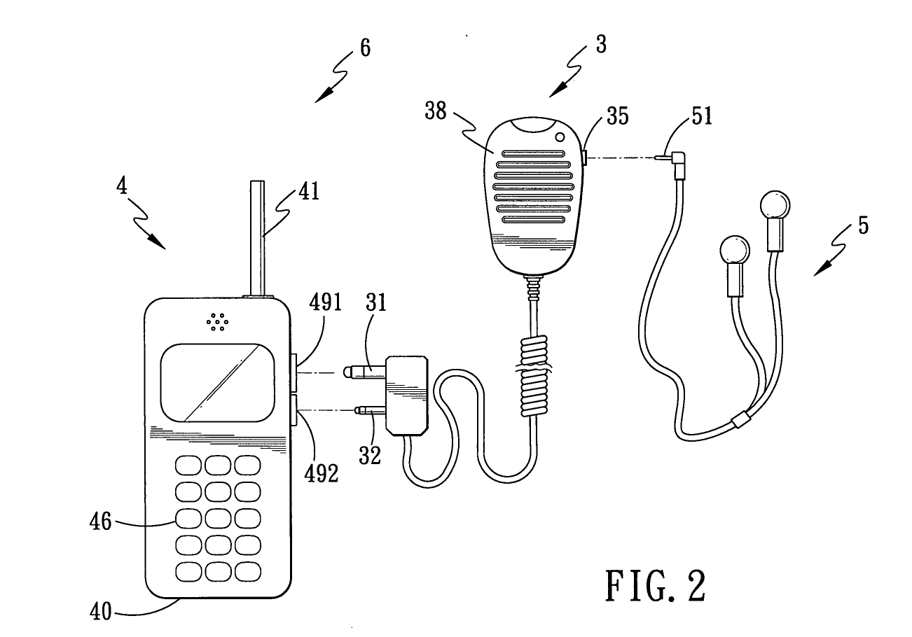

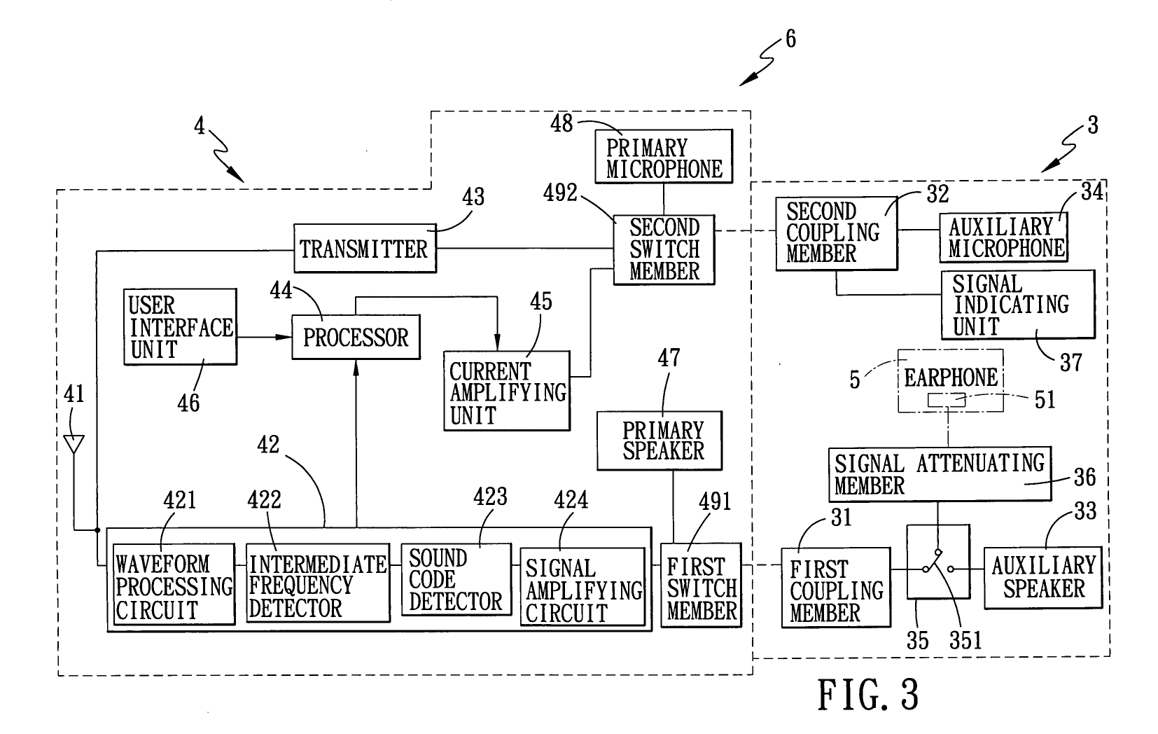

Referring to FIGS. 2 to 4, the preferred embodiment of a wireless intercommunicating apparatus 6 according to the present invention is shown to include a wireless intercommunicating device 4 and an auxiliary device 5.

The wireless intercommunicating device 4 includes a primary housing 40, anantenna 41 mounted on the primary housing 40, a first switch member 491 mounted on the primary housing 40, a second switch member 492 mounted on the primary housing 40, a receiver 42 mounted in the primary housing 40 and interconnecting electrically the antenna 41 and the first switch member 491, a transmitter 43 mounted in the primary housing 40 and interconnecting electrically the second switch member 492 and the antenna 41, a primary speaker 47 mounted in the primary housing 40 and coupled to the first switch member 491, a primary microphone 48 mounted on the primary housing 40 and coupled to the second switch member 492, and a processor 44 mounted in the primary housing 40 and connected electrically to the receiver 42 and the second switch member 492.

The receiver 42 receives an incoming radio frequency signal via the antenna 41, and generates an audio signal corresponding to the incoming radio frequency signal via the first switch member 491. In this embodiment, the receiver 42 includes a waveform processing circuit 421, an intermediate frequency detector 422, a sound code detector 423, and a signal amplifying circuit 424. The waveform processing circuit 421 amplifies, filters and mixes the incoming audio frequency signal received by the antenna 41 so as to obtain an intermediate frequency signal. The intermediate frequency detector 422 extracts an audio signal component from the intermediate frequency signal, and judges whether the amplitude of the audio signal component reaches a predetermined amplitude. The sound code detector 423 detects whether the audio signal component contains noise. The signal amplifying circuit 424 amplifies the audio signal component so as to generate the audio signal, and the receiver 42 generates a confirm signal upon judging that the amplitude of the audio signal component reached the predetermined amplitude and detecting that the audio signal component has no noise.

The processor 44 generates a driving signal upon detecting generation of the audio signal (i.e., upon receiving the confirming signal from the receiver 42), and outputs the driving signal via the second switch member 492.

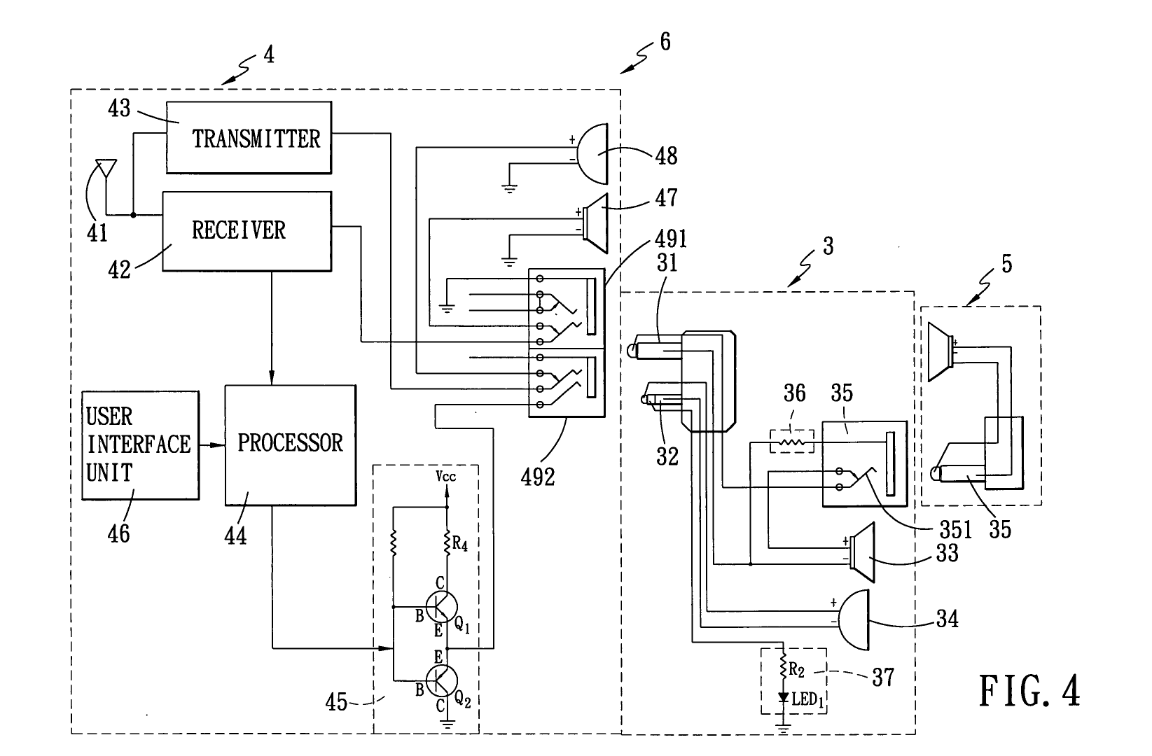

The wireless intercommunicating device 4 further includes a current amplifying unit 45 interconnecting electrically the processor 44 and the second switch member 492 for amplifying the driving signal from the processor 44. In this embodiment, as shown in FIG. 4, the current amplifying unit 45 includes a complementary pair of emitter-coupled transistors composed of an npn-transistor (Q1) and a pnp-transistor (Q2). As a result of larger input impedance and smaller output impedance characteristics for the emitter-coupled transistors, the emitter-coupled transistors provide a current gain of 1+β (β is a common emitter forward current amplification factor).

In this embodiment, when the wireless intercommunicating device 4 is used independently, the primary speaker 47 is connected electrically to the receiver 42 such that the primary speaker 47 reproduces the audio signal therefrom, and the primary microphone 48 is connected electrically to the transmitter 43 such that the incoming audio signal received by the primary microphone 48 is transmitted to the transmitter 43.

The wireless intercommunicating device 4 further includes a user interface unit 46 connected electrically to the processor 44 and operable so as to generate an input command to the processor 44 such that the processor 44 is able to adjust the receiver 42 in response to the input command from the user interface unit 46 in a known manner.

The auxiliary device 3 includes an auxiliary housing 38, an earphone switch port 35, a first coupling member 31, an auxiliary speaker 33, an auxiliary microphone 34, a second coupling member 32, and a signal indicating unit 37.

In this embodiment, the auxiliary housing 38 has a size smaller than that of the primary housing of the intercommunicating device 4, as shown in FIG. 2, thereby facilitating carrying and handling of the same.

The earphone switch port 35 is mounted on the auxiliary housing 38, and is adapted to be connected to an earphone 5.

The first coupling member 31 is wiredly connected to the earphone switch port 35, and is connected detachably and electrically to the first switch member 491 of the wireless intercommunicating device 4. It is noted that the first switch member 491 of the wireless intercommunicating device 4 is switched so as to disconnect the primary speaker 47 from the receiver 42 of the wireless intercommunicating device 4 when the first coupling member 31 is connected electrically to the first switch member 491 of the wireless intercommunicating device 4. In this embodiment, the first coupling member 31 is a plug.

The auxiliary speaker 33 is mounted in the auxiliary housing 38, and is coupled to the earphone switch port 35.

The earphone switch port 35 switches operation from a first state, where the first coupling member 31 is connected electrically to the auxiliary speaker 33 such that the auxiliary speaker 33 reproduces the audio signal from the receiver 42 of the wireless intercommunicating device 4 when the earphone switch port 35 is disconnected from the earphone 5, to a second state, where the first coupling member 31 is disconnected from the auxiliary speaker 33 and enables the earphone 5 to reproduce the audio signal from the receiver 42 of the wireless intercommunicating device 4 when the earphone switch port 35 is connected to the earphone 5. In this embodiment, the earphone switch port 35 includes a switching piece 351 that interconnects electrically the first coupling member 31 and the auxiliary speaker 33 when the earphone switch port 35 is in the first state and that is driven by the earphone 5 to disconnect the auxiliary speaker 33 and interconnect the first coupling member 31 and the earphone 5 when the earphone switch port is in the second state.

The auxiliary microphone 34 is mounted on the auxiliary housing 38 for receiving an incoming audio signal.

The second coupling member 32 is wiredly connected to the auxiliary microphone 34 and is connected detachably and electrically to the second switch member 492 of the wireless intercommunicating device 4 such that the incoming audio signal received by the auxiliary microphone 34 is transmitted to the transmitter 43 of the wireless intercommunicating device 4 via the second coupling member 32 and the second switch member 492. It is noted that the second switch member 492 of the wireless intercommunicating device 4 is switched so as to disconnect the primary microphone 48 from the transmitter 43 of the wireless intercommunicating device 4 when the second coupling member 32 is connected electrically to the second switch member 492 of the wireless intercommunicating device 4. In this embodiment, the second coupling member 32 is a plug.

The signal indicating unit 37 is connected electrically to the second coupling member 32, and is driven by the driving signal from processor 44 of the wireless intercommunicating device 4 via the second switch member 492 and the second coupling member 32 so as to indicate receipt of the incoming radio frequency signal by the wireless intercommunicating device 4. In this embodiment, the signal indicating unit 37 includes a light emitting diode (LED1), as shown in FIG. 4. However, the signal indicating unit 37 can also be composed of a vibration motor or a combination of a light emitting diode and a vibration motor (not shown).

In addition, the auxiliary device 3 further includes a signal attenuating member 36 coupled to the earphone switch port 35 for attenuating the audio signal transmitted from the receiver 42 of the wireless intercommunicating device 4 to the earphone 5 when the earphone switch port 35 is in the second state. In this embodiment, the signal attenuating member 36 is a resistor, as shown in FIG. 4. However, the signal attenuating member 36 can also be a variable resistor or a transformer.

To sum up, since the signal indicating unit 37 can indicate receipt of the incoming radio frequency signal by the wireless intercommunicating device 4, the wireless intercommunicating apparatus 3 of this invention can avoid missing of the incoming radio frequency signal received by the wireless intercommunicating device 4 even though the apparatus 3 is used in a noisy environment. Moreover, due to the presence of the signal attenuating member 36, the audio signal reproduced by the earphone 5 can be attenuated to a more comfortable level so as to meet user requirements.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A wireless intercommunicating apparatus comprising:
a wireless intercommunicating device including
a primary housing,
an antenna mounted on said primary housing,
a first switch member mounted on said primary housing,
a second switch member mounted on said primary housing,
a receiver mounted in said primary housing and interconnecting electrically said antenna and said first switch member for receiving an incoming radio frequency signal via said antenna, said receiver generating an audio signal corresponding to the incoming radio frequency signal and outputting the audio signal via said first switch member,
a transmitter mounted in said primary housing and interconnecting electrically said second switch member and said antenna, and
a processor mounted in said primary housing, connected electrically to said receiver and said second switch member, generating a driving signal upon detecting generation of the audio signal, and outputting the driving signal via said second switch member; and
an auxiliary device including
an auxiliary housing,
an earphone switch port mounted on said auxiliary housing and adapted to be connected to an earphone,
a first coupling member wiredly connected to said earphone switch port and connected detachably and electrically to said first switch member of said wireless intercommunicating device,
an auxiliary speaker mounted in said auxiliary housing and coupled to said earphone switch port,
said earphone switch port switching operation from a first state, where said first coupling member is connected electrically to said auxiliary speaker such that said auxiliary speaker reproduces the audio signal from said receiver of said wireless intercommunicating device when said earphone switch port is disconnected from the earphone, to a second state, where said first coupling member is disconnected from said auxiliary speaker and enables the earphone to reproduce the audio signal from said receiver of said wireless intercommunicating device when said earphone switch port is connected to the earphone,
an auxiliary microphone mounted on said auxiliary housing for receiving an incoming audio signal,
a second coupling member wiredly connected to said auxiliary microphone and connected detachably and electrically to said second switch member of said wireless intercommunicating device such that the incoming audio signal received by said auxiliary microphone is transmitted to said transmitter of said wireless intercommunicating device via said second coupling member and said second switch member, and
a signal indicating unit connected electrically to said second coupling member and driven by the driving signal from said processor of said wireless intercommunicating device via said second switch member and said second coupling member so as to indicate receipt of the incoming radio frequency signal by said wireless intercommunicating device.

2. The wireless intercommunicating apparatus as claimed in claim 1, wherein said auxiliary housing has a size smaller than that of said primary housing of said wireless intercommunicating device.

3. The wireless intercommunicating apparatus as claimed in claim 1, wherein said wireless intercommunicating device further includes a current amplifying unit interconnecting electrically said processor and said second switch member for amplifying the driving signal from said processor.

4. The wireless intercommunicating apparatus as claimed in claim 1, wherein said signal indicating unit includes a light emitting diode.

5. The wireless intercommunicating apparatus as claimed in claim 1, wherein said signal indicating unit includes a vibration motor.

6. The wireless intercommunicating apparatus as claimed in claim 1, wherein said wireless intercommunicating device further includes
a primary speaker mounted in said primary housing and coupled to said first switch member, said primary speaker being connected electrically to said receiver via said first switch member such that said primary speaker reproduces the audio signal therefrom when said first coupling member of said auxiliary device is disconnected from said first switch member, said primary speaker being disconnected from said receiver when said first coupling member of said auxiliary device is connected electrically to said first switch member, and
a primary microphone mounted on said primary housing and coupled to said second switch member for receiving an incoming audio signal, said primary microphone being connected electrically to said transmitter via said second switch member such that the incoming audio signal received by said primary microphone is transmitted to said transmitter when said second coupling member of said auxiliary device is disconnected from said second switch member, said primary microphone being disconnected from said transmitter when said second coupling member of said auxiliary device is connected electrically to said second switch member.

7. The wireless intercommunicating apparatus as claimed in claim 1, wherein said auxiliary device further includes a signal attenuating member coupled to said earphone switch port for attenuating the audio signal transmitted from said receiver of said wireless intercommunicating device to the earphone when said earphone switch port is in the second state.

8. The wireless intercommunicating apparatus as claimed in claim 7, wherein said signal attenuating member is a resistor.

9. The wireless intercommunicating apparatus as claimed in claim 1, wherein each of said first and second coupling members is a plug.

10. A wireless intercommunicating device comprising:
a housing;
an antenna mounted on said housing;
a first switch member mounted on said housing;
a second switch member mounted on said housing;
a receiver mounted in said housing and interconnecting electrically said antenna and said first switch member for receiving an incoming radio frequency signal via said antenna, said receiver generating an audio signal corresponding to the incoming radio frequency signal and outputting the audio signal via said first switch member;
a transmitter mounted in said housing and interconnecting electrically said second switch member and said antenna; and
a processor mounted in said housing, connected electrically to said receiver and said second switch member, generating a driving signal upon detecting generation of the audio signal, and outputting the driving signal via said second switch member.

11. The wireless intercommunicating device as claimed in claim 10, further comprising a current amplifying unit mounted in said housing and interconnecting electrically said processor and said second switch member for amplifying the driving signal from said processor.

12. The wireless intercommunicating device as claimed in claim 10, further comprising:
a speaker mounted in said housing and coupled to said first switch member, said speaker being connected electrically to said receiver via said first switch member such that said speaker reproduces the audio signal from said receiver; and
a microphone mounted on said housing and coupled to said second switch member for receiving an incoming audio signal, said microphone being connected electrically to said transmitter via said second switch member such that the incoming audio signal received by said microphone is transmitted to said transmitter.

13. An auxiliary device for use with a wireless intercommunicating device, the wireless intercommunicating device including
a primary housing,
an antenna mounted on the primary housing,
a first switch member mounted on the primary housing,
a second switch member mounted on the primary housing,
a receiver mounted in the primary housing and interconnecting electrically the antenna and the first switch member for receiving an incoming radio frequency signal via the antenna, the receiver generating an audio signal corresponding to the incoming radio frequency signal and outputting the audio signal via the first switch member,
a transmitter mounted in the primary housing and interconnecting electrically the second switch member and the antenna, and
a processor mounted in the primary housing, connected electrically to the receiver and the second switch member, generating a driving signal upon detecting generation of the audio signal, and outputting the driving signal via the second switch member,
said auxiliary device comprising:
an auxiliary housing;
an earphone switch port mounted on said auxiliary housing and adapted to be connected to an earphone;
a first coupling member wiredly connected to said earphone switch port and adapted to be connected detachably and electrically to the first switch member of the wireless intercommunicating device;
an auxiliary speaker mounted in said auxiliary housing and coupled to said earphone switch port;
said earphone switch port switching operation from a first state, where said first coupling member is connected electrically to said auxiliary speaker such that said auxiliary speaker reproduces the audio signal from the receiver of the wireless intercommunicating device when said earphone switch port is disconnected from the earphone, to a second state, where said first coupling member is disconnected from said auxiliary speaker and enables the earphone to reproduce the audio signal from the receiver of the wireless intercommunicating device when said earphone switch port is connected to the earphone;
an auxiliary microphone mounted on said auxiliary housing for receiving an incoming audio signal;
a second coupling member wiredly connected to said auxiliary microphone and adapted to connected detachably and electrically to the second switch member of the wireless intercommunicating device such that the incoming audio signal received by said auxiliary microphone is transmitted to the transmitter of the wireless intercommunicating device via said second coupling member and the second switch member; and
a signal indicating unit connected electrically to said second coupling member and driven by the driving signal from the processor of the wireless intercommunicating device via said second switch member and said second coupling member so as to indicate receipt of the incoming radio frequency signal by the wireless intercommunicating device.

14. The auxiliary device as claimed in claim 13, wherein said auxiliary housing has a size smaller than that of the primary housing of the wireless intercommunicating device.

15. The auxiliary device as claimed in claim 13, wherein said signal indicating unit includes a light emitting diode.

16. The auxiliary device as claimed in claim 13, wherein said signal indicating unit includes a vibration motor.

17. The auxiliary device as claimed in claim 13, further comprising a signal attenuating member coupled to said earphone switch port for attenuating the audio signal transmitted from the receiver of the wireless intercommunicating device to the earphone when said earphone switch port is in the second state.

18. The auxiliary device as claimed in claim 17, wherein said signal attenuating member is a resistor.

19. The auxiliary device as claimed in claim 13, wherein each of said first and second coupling members is a plug.
